(19) United States
(12) Patent Application Publication
(10) Pub. No.: US 2002/0135564 A1
(43) Pub. Date: Sep. 26, 2002

(54) Combined keyboard and mouse

(76) Inventor: Toshiyasu Abe, Bellevue, WA (US)

Correspondence Address: BLACK LOWE & GRAHAM, 816 SECOND AVE., SEATTLE, WA, 98104, US

(21) Appl. No.: 09/818,031

(22) Filed: Mar. 26, 2001

(51) Int. Cl. G09G 5/00

(52) U.S. Cl. 345/168

(57) ABSTRACT

A user interface device coupled to a processor for allowing a user to quickly switch from a typing mode of operation to a mouse mode of operation. The processor is coupled to a display device. The user interface device includes a plurality of keys that generates keyboard signals in a keyboard operation mode, a motion sensor that senses user interface device motion and generates graphical user interface signals in a graphical user interface operation mode based on sensed user interface device motion, and a switch that switches the keyboard between the keyboard operation mode and the graphical user interface operation mode.

### FIELD OF THE INVENTION

This invention relates to keyboards and cursor control devices and more particularly the invention relates to multifunctional keyboards and cursor control devices.

### BACKGROUND OF THE INVENTION

Traditional computer user interface devices include a keyboard for entering alphanumeric information, a display for displaying graphical user interfaces of application programs and a cursor control device for allowing a user to control operation of application programs. A typical cursor control device is a mouse that is separate from the keyboard. The mouse controls movement of a displayed cursor and selection of functions on the display. The user must remove a hand from the keyboard in order to use the mouse. This becomes inefficient if the application program requires the user to switch often between keyboard and mouse operations.

A multidirectional nipple allows the user's hand to stay in close proximity to the keys while performing cursor control. However, this device still requires the user to remove their fingers from direct contact with the keyboard keys. For example, on a QWERTY keyboard the user's right hand fingers are placed on the J, K, L, and; keys for maximum efficiency when performing keyboard operations. When the user is switching from nipple operation to keyboard operation, some inefficiencies occur as the user's fingers reacquire the keys.

It is therefore an objective of this invention to resolve some of these problems and provide an improved keyboard and mouse system.

### SUMMARY OF THE INVENTION

The present invention provides a user interface device coupled to a processor for allowing a user to quickly switch from a typing mode of operation to a mouse mode of operation. The processor is coupled to a display device. The user interface device includes a plurality of keys that generates keyboard signals in a keyboard operation mode, a motion sensor that senses user interface device motion and generates graphical user interface signals in a graphical user interface operation mode based on sensed user interface device motion, and a switch that switches the keyboard between the keyboard operation mode and the graphical user interface operation mode.

In accordance with further aspects of the invention, the motion sensor is an optical sensor.

In accordance with other aspects of the invention, the user interface device further includes a bottom, middle and top layer, wherein the middle layer slides in a first direction on the bottom layer and the top layer slides in a second direction on the middle layer, the second direction being orthogonal to the first direction.

In accordance with still further aspects of the invention, the motion sensor includes a first sensor that senses middle layer motion over the bottom layer and a second sensor that senses top layer motion over the middle layer. A brake is included to reduce motion between the layers.

In accordance with yet other aspects of the invention, the user interface device further includes a brake release sensor that causes the brake to release when activated by a user.

In accordance with still another aspect of the invention, the user interface device further includes a graphical user interface activator. The graphical user interface activator includes a first set of keys that generates a first signal upon activation of one or more of the keys in the first set, and a second set of keys that generates a second signal upon activation of one or more of the keys in the second set. The processor controls a graphical user interface presented on the display in response to the first or second signal. Each of the first and second set of keys includes a portion of the plurality of keys that generates keyboard signals.

### BRIEF DESCRIPTION OF THE DRAWINGS

The preferred embodiment of the present invention is described in detail below with reference to the following drawings:

FIG. 1 is a block diagram of the components of the present invention;

FIGS. 2 is a flow diagram of a process performed by the components of FIG. 1;

FIGS. 3 and 4 are a top view of an embodiment of the present invention;

FIG. 5 is a cross-sectional view of the embodiment shown in FIGS. 3 and 4;

FIG. 6 is a partial x-ray top view of the embodiment shown in FIGS. 3 and 4;

FIGS. 7 is a top view of an alternate embodiment of the present invention; and

FIG. 8 is a cross-sectional view of the embodiment shown in FIG. 7.

### DETAILED DESCRIPTION OF THE PREFERRED EMBODIMENT

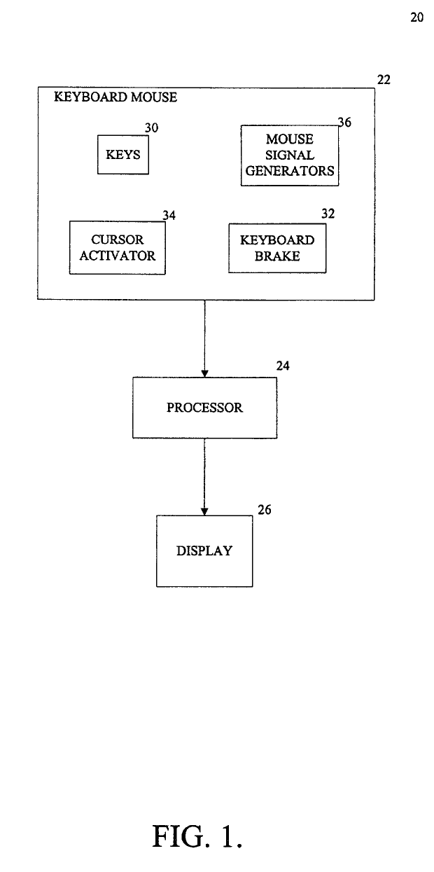

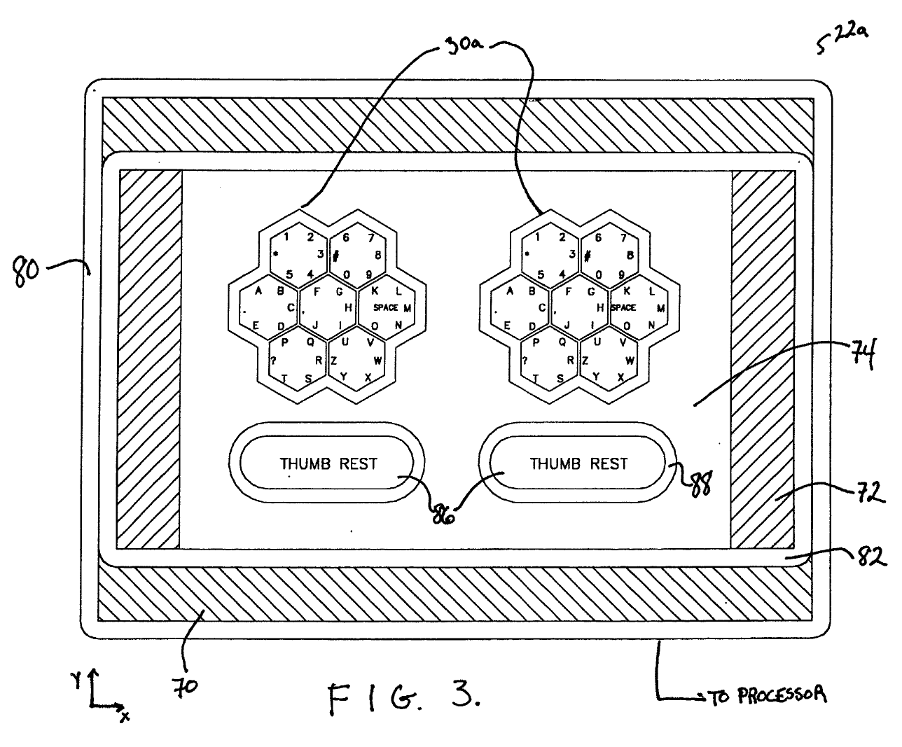

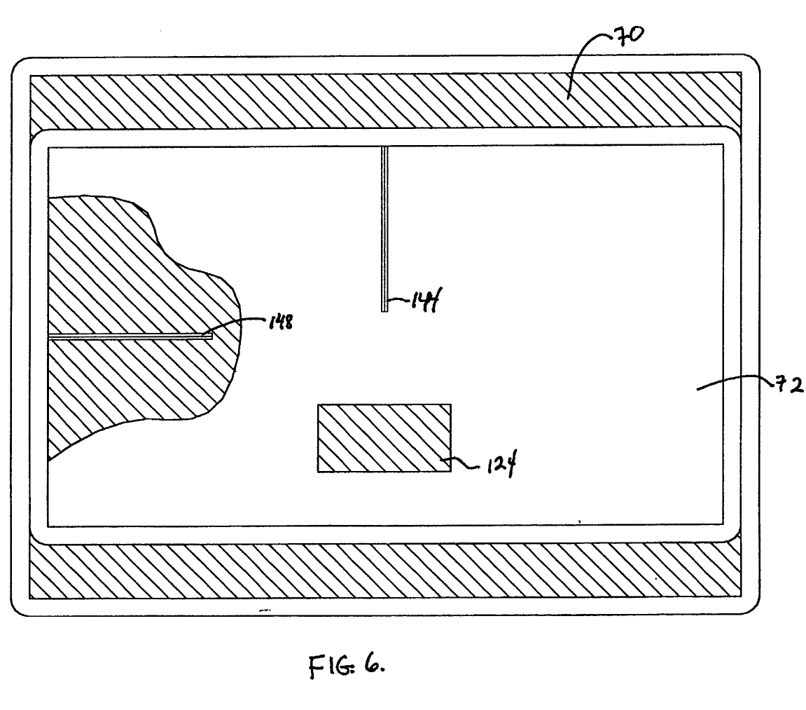

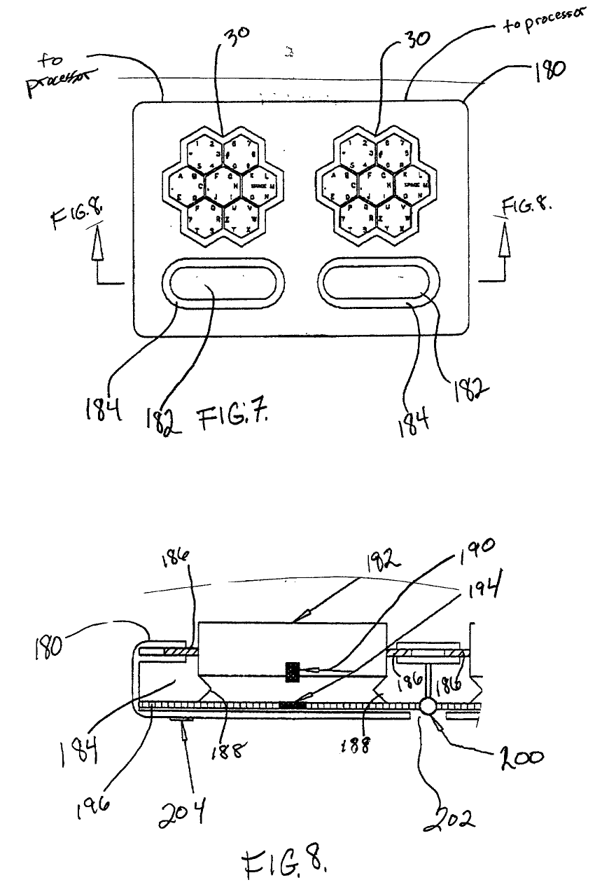

FIG. 1 illustrates a computer user interface system 20 that includes a keyboard mouse 22 formed in accordance with the present invention. The keyboard mouse 22 is in signal communications with a processor 24, which is in signal communications with a display 26. The keyboard mouse 22 includes a number of items that are typical with keyboards, such as a set of keys 30 and a mechanism that allows the keys 30 to generate signals that are then processed by the processor 24. In order for the keyboard mouse 22 to perform as a mouse or cursor control device, the keyboard mouse 22 includes a keyboard brake 32, a cursor activator 34, and mouse signal generators 36. An example embodiment of the components included within the keyboard mouse 22 is shown in FIGS. 3-6. An alternate embodiment shown in FIGS. 7 and 8 does not include the keyboard brake 32, but can also perform the same keyboard and mouse functions as described above.

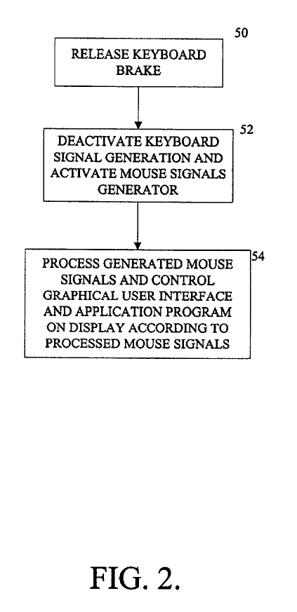

FIG. 2 illustrates a process performed by the components shown in FIG. 1 for converting the keyboard mouse 22 from operating as a keyboard to operating as a mouse. First, at block 50, the user releases the keyboard brake 32. At block 52, keyboard signal generation is deactivated (i.e., depressing a key does not cause the processor to display the corresponding alphanumeric character) and activates generation and processing of mouse signals. Mouse signals include cursor movement signals and function selection signals. At block 54, the processor 24 processes any generated mouse signals and controls a graphical user interface according to the processed mouse signals.

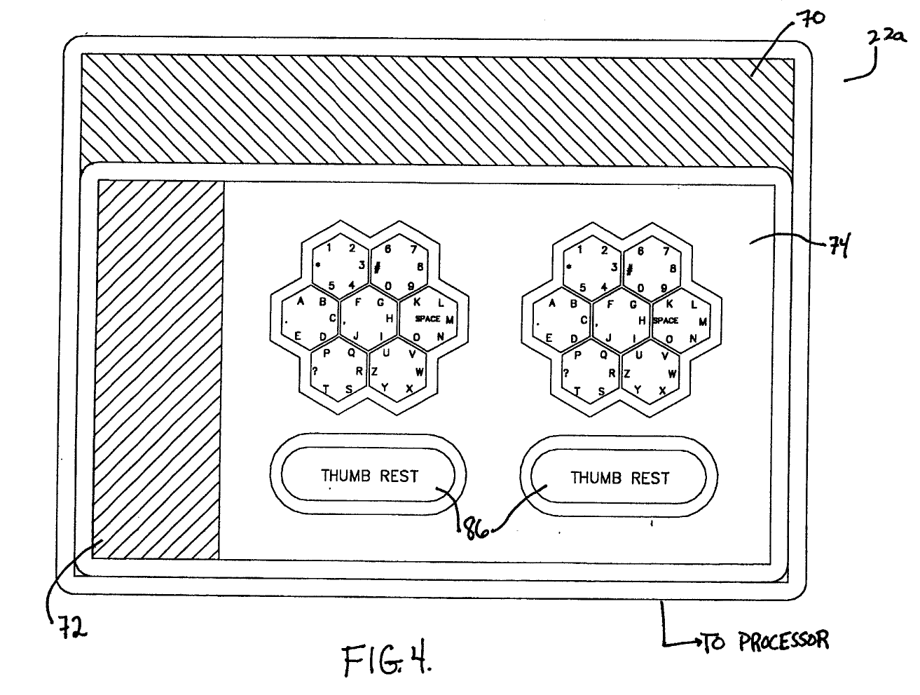

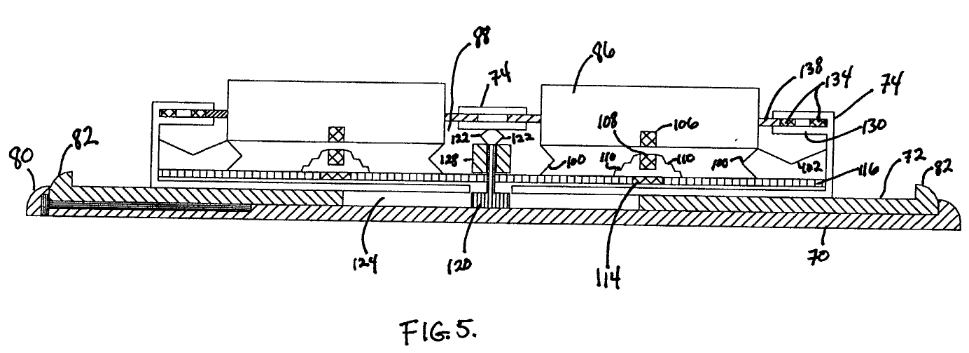

FIG. 3 illustrates a top view of an embodiment of the keyboard mouse 22a. The keyboard mouse 22a includes three layers; a bottom layer 70, a middle layer 72 and a top layer 74. The top layer 74 rests on the middle layer 72 and the middle layer 72 rests on the bottom layer 70. The top layer 74 includes keys 30a for entering alphanumeric characters and for performing user interface functions, and two thumb pads 86 housed within thumb pad cavities 88. The keys 30a can be formatted in a standard QWERTY, Dvorak or other layout. The present invention can also be used in conjunction with a conventional keyboard. The keyboard layout shown in FIG. 3 is described in more detail in copending U.S. patent application Ser. No. 09/785,813, filed Feb. 16, 2001, titled “IMPROVED KEYBOARD”, which is hereby incorporated by reference. The thumb pads 86 provide the functions performed by the mouse function activator 34 and the keyboard brake 32. The bottom and middle layers 70, 72 each include a side rail 80, 82 that keep the layer that rests on it sliding in the x or y direction. The rails 80, 82 also form an attachment to the layer above. The middle layer 72's x dimension is approximately equal to the x dimension between the bottom layers rail 80. The y dimension of the middle layer 72 is less than the y dimension of the bottom layer 70, thus allowing the middle layer 72 to slide in the y direction on top of the bottom layer 70. The top layer 74's y dimension is approximately equal to the y dimension between the middle layer's rail 82. The x dimension of the top layer 74 is less than the x dimension between the middle layer's rail 82, thus allowing the top layer 74 to slide in the x direction on top of the middle layer 72. A side view of the rails 80, 82 is shown in FIG. 5. The rail 80 provides a guide for motion travel along a first lateral direction axis and provides stops for motion travel along second lateral direction axis, wherein the first axis is orthogonal to the second axis. The rail 82 provides a guide for motion travel along the second lateral axis and provides stops for motion travel along the first lateral axis. When the keyboard 22a is in the mouse operation mode, the x and y motion between the layers is sensed by motion sensor's, an example of which is shown in FIG. 6.

FIG. 4 illustrates the keyboard configuration shown in FIG. 3 when the keyboard 22a is moved into the lower right position. In other words, the middle layer 72 is at its lowest point of travel in the y dimension on the bottom layer 70 and the top layer 74 is at its farthest right position on top of the middle layer 72.

FIG. 5 is a cross sectional view through the thumb pad 86 from FIG. 3. The thumb pads 86 are mounted to vertical springs 100 and horizontal springs 102 within the cavity 88. The springs 100, 102 allow the thumb pads to move both vertically and laterally from a normal at rest position, as shown. At the thumb pads base is a sensor activator 106. Underneath the sensor activator 106 is a brake release sensor 108 mounted on a spring like device 110 that keeps it raised above the base of the cavity 88 and away from the thumb pad base when the thumb pad is at its normal at rest position. Below the brake release sensor 108 is a cursor sensor 114 that is mounted in a sensor layer 116 that rests on or near the base of the cavity 88.

A brake 120 is mounted between each of the thumb pads 86. The brake 120 is held by spring like devices 122 to the underside of a top of a housing for the top layer 74. The brake 120 passes through an actuator device 128, such as a solenoid, below the spring like devices 122, then through the sensor layer 116 and an opening at the base of the top layer 74 to a cavity 124. The cavity 124 is formed at its base by the bottom layer 70 and at its sides by the middle layer 72. This cavity 124 is essentially a cutout of the middle layer 72, shown in more detail from a top view in FIG. 6 below. When the brake 120 is in contact with the bottom layer 70, the top layer 74 does not move relative to the bottom layer 70. The bottom of the brake 120 is preferably a gripping material, such as a rubber compound, that keeps the brake 120 from sliding on the surface of the bottom layer 70.

When the thumb pad 86 is depressed to a position where the sensor 106 comes in contact with the brake release sensor 108, without depressing the brake release sensor 108 to the position where it comes in contact with the cursor sensor 114, a signal is sent through the processor to the solenoid 128 or directly to the solenoid 128 for activating the solenoid 128 to move the brake 120 vertically. This releases brake contact with the surface of the bottom layer 70. When the thumb pad 86 is further depressed to the position where the brake release sensor 108 comes in contact with the cursor sensor 114, a signal is sent to the processor instructing the processor that the keyboard mouse 22a is no longer in the keyboard mode but is now in the mouse function mode. The keyboard mouse 22a then generates mouse signals according to user motion of the layers and activation of the keys 30a. Not shown in FIG. 5 are the sensors that detect the x and y motion of the layers. FIG. 6 shows an example of this below.

FIG. 6 is a partial X-ray, top view of the keyboard mouse 22a shown in FIGS. 3 through 5. Between the top layer 74 and the middle layer 72 is a first keyboard motion sensor 144. The motion sensor 144 senses x direction motion of the top layer 74 over the middle layer 72. When the motion sensor 144 is activated, the motion sensor 144 sends cursor control signals to the processor 24. The signals generated by the motion sensor 144 are processed by the processor to direct x motion of a cursor and the display 26. A second keyboard motion sensor 148 senses y direction motion of the middle layer 72 over the bottom layer 70. The sensed y direction motion of the middle layer 72 is sent as a signal to the processor 24. The processor 24 processes the sent signal and directs y motion of the cursor on the display 26 accordingly.

Also shown in FIG. 6 is a top view of the cutout cavity 124 of the middle layer 72. In an alternate embodiment the dimensions of the cavity 124 are proportional to the dimensions of the display 26.

An alternate embodiment of the present invention is shown in FIGS. 7 and 8. In this embodiment, the mouse motion signals are not generated by a sensor sensing motion between two layers. No moving layers are present in this embodiment. FIG. 7 is a top view of a keyboard mouse 180. The keyboard mouse 180 appears similar to the top layer 74 shown in FIG. 3 with two sets of keys 30 and two thumb pads 182 resting in cavities 184. FIG. 8 is a cross-sectional view through the thumb pad 182 of FIG. 7. The thumb pads 182 are supported laterally by a support structure 186. The support structure 186 allows lateral movement and allows for depression of the thumb pads 182. The thumb pads 182 are supported vertically by spring like supports 188 within the cavity 184. A first mouse motion activation 190 is mounted on the base of the thumb pad 182.

A second mouse motion activator 194 generates a cursor mode signal when the first key sensor 190 is sensed to be within a threshold distance of the second key sensor 194. A processor (not shown) receives the cursor mode signal and switches from a keyboard mode to a cursor mode.

The base of the housing of the keyboard mouse 180 includes a section 202 that is removed. Within the removed section 202 is a keyboard mouse motion sensor 200 that is mounted via a stem to the underside of the topside of the housing or to a sensor layer 196 that includes the second cursor sensor 194 and is positioned at the base of the cavity 184. The keyboard mouse motion sensor 200 detects motion of the keyboard mouse 180 as it slides on a smooth surface using glides 204, preferably Teflon glides, that are mounted to the underside of the keyboard mouse 180. The keyboard mouse motion sensor 200 is preferably an optical motion sensor, such as that used in an optical mouse. Other motion sensors, such as a mouse rollerball sensor, can be used.

In an alternate embodiment, the functions normally associated with the left and right buttons on a mouse are associated with the two sets of keys 30. When the keyboard mouse 22a or 180 is operating in a mouse or cursor mode of operation, depression of one or more of the keys in the left set of keys generates a mouse signal comparable to activating the left mouse button and depression of one or more of the keys in the right set of keys generates a mouse signal comparable to activating the right mouse button.

In a similar embodiment to that above, the functions normally associated with the left, middle and right buttons on a mouse are associated with specific keys in the keyboard layout shown in FIG. 3. The sets of keys for the left and right hands each have three keys that are designated as the home row keys. On the set of keys for the left hand, the home row keys are on the left middle key that is in contact with the user's left ring finger, the middle key that is in contact with the user's middle finger and the bottom right key that is in contact with the user's pointer finger. On the set of keys for the right hand, the home row keys are on the right middle key that is in contact with the user's right ring finger, the middle key that is in contact with the user's middle finger and the bottom left key that is in contact with the user's pointer finger. Depression of either of the leftmost keys of the home row keys generates a mouse signal comparable to activating the left mouse button. Depression of either of the middle keys of the home row keys generates a mouse signal comparable to activating the middle mouse button and depression of either of the rightmost keys of the home row keys generates a mouse signal comparable to activating the right mouse button.

While the preferred embodiment of the invention has been illustrated and described, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A user interface device coupled to a processor, the processor coupled to a display device, the user interface device comprising:
a plurality of keys configured to generate keyboard signals in a keyboard operation mode;
a motion sensor configured to sense user interface device motion and generate graphical user interface signals in a graphical user interface operation mode based on sensed user interface device motion; and
a switch configured to switch the keyboard between the keyboard operation mode and the graphical user interface operation mode.

2. The device of claim 1, wherein the motion sensor is an optical sensor.

3. The device of claim 1, wherein the user interface device further comprises a bottom, middle and top layer, wherein the middle layer slides in a first direction on the bottom layer and the top layer slides in a second direction on the middle layer, the second direction being orthogonal to the first direction.

4. The device of claim 3, wherein the motion sensor comprises a first sensor configured to sense middle layer motion over the bottom layer and a second sensor configured to sense top layer motion over the middle layer.

5. The device of claim 4, the user interface device further comprises a brake configured to reduce motion between the layers.

6. The device of claim 4, the user interface device further comprises a brake release sensor configured to cause the brake to release when activated by a user.

7. The device of claim 1, the user interface device further comprises a graphical user interface activator.

8. The device of claim 7, graphical user interface activator comprises:
a first set of keys configured to generate a first signal upon activation of one or more of the keys in the first set; and
a second set of keys configured to generate a second signal upon activation of one or more of the keys in the second set,
wherein the processor controls a graphical user interface presented on the display in response to the first or second signal.

9. The device of claim 8, wherein the first and second set of keys each comprise a portion of the plurality of keys configured to generate keyboard signals.

10. A user interface method using a user interface device coupled to a processor, the processor coupled to a display device, the method comprising:
generating keyboard signals in a keyboard operation mode;
sensing user interface device motion;
generating graphical user interface signals in a graphical user interface operation mode based on the sensed user interface device motion; and
selecting between the keyboard operation mode and the graphical user interface operation mode.

11. The method of claim 10, wherein sensing is optical sensing.

12. The method of claim 1, the user interface device comprises a bottom, middle and top layer, wherein the middle layer slides in a first direction on the bottom layer and the top layer slides in a second direction on the middle layer, the second direction being orthogonal to the first direction,
wherein sensing comprises first sensing middle layer motion over the bottom layer and second sensing top layer motion over the middle layer

13. The method of claim 12, the method further comprises braking between the layers.

14. The method of claim 13, activating a brake release sensor thereby cause a release of braking.

15. The method of claim 10, activating graphical user interface control functions.
